(19) United States
(12) Patent Application Publication
(10) Pub. No.: US 2013/0168262 A1
(43) Pub. Date: Jul. 4, 2013

(54) METHOD AND SYSTEM FOR ELECTROCHEMICAL REMOVAL OF NITRATE AND AMMONIA

(71) Applicants: David Reyter, Montreal (CA); Lionel Roue, Sainte-Julie (CA); Daniel Belanger, St-Hubert (CA)

(72) Inventors: David Reyter, Montreal (CA); Lionel Roue, Sainte-Julie (CA); Daniel Belanger, St-Hubert (CA)

(73) Assignees: TRANSFERT PLUS, S.E.C., MONTREAL, QC (CA); INSTITUT NATIONAL DE LA RECHERCHE SCIENTIFIQUE, QUEBEC, QC (CA)

(21) Appl. No.: 13/821,695

(22) PCT Filed: Sep. 20, 2011
(86) PCT No.: PCT/CA11/50575

§ 371 Date: Mar. 8, 2013

Related U.S. Application Data
(60) Provisional application No. 61/384,877, filed on Sep. 21, 2010.

(51) Int. Cl. C02F 1/467

(52) U.S. Cl. CPC C02F 1/4676
USPC 205/743; 204/275.1; 205/742; 204/230.2; 204/229.4

(57) ABSTRACT

An electrochemical method and system for removing nitrate and ammonia in effluents, using an undivided flow-through electrolyzer, said electrolyzer comprising at least one cell, each cell comprising at least one anode and one cathode, the cathode being in a copper/nickel based alloy of a high corrosion resistance and a high electroactivity for nitrate reduction to ammonia and the anode being a DSA electrode of a high corrosion resistance and a high electroactivity for ammonia oxidation to nitrogen in presence of chloride.

### FIELD OF THE INVENTION

The present invention relates to nitrate and ammonia removal. More specifically, the present invention is concerned with a method and a system for electrochemical conversion of nitrate and ammonia to nitrogen.

### BACKGROUND OF THE INVENTION

Due to the increasing use of synthetic nitrogen fertilizers, livestock manure in intensive agriculture, industrial and municipal effluent discharge, nitrate (NO₃⁻) and ammonia (NH₃/NH₄⁺) contamination in ground and surface waters is now widespread (Puckett, 1995). This pollution has detrimental effects on human health and on the aquatic ecosystems. The World Health Organization recommends a maximum limit of 45 ppm and 1.5 ppm of nitrate and ammonia, respectively, in drinking water.

Two nitrate reduction processes predominantly used are ion exchange and biological denitrification. Membrane processes such as electrodialysis reversal (El Midaoui et al., 2002) and reverse osmosis (Schoeman and Steyn, 2003) can also be used for nitrate removal. Biological nitrification, oxidation by chlorine and air stripping are conventional methods for ammonia removal. Unfortunately, these processes show some drawbacks, such as, for example, the need for continuous monitoring, slow kinetics and generation of byproducts. Electrochemical approaches are receiving more and more attention due to their convenience, low investment cost and environmental friendliness, particularly when the resulting product is harmless nitrogen (Rajeshwar and Ibanez, 2000).

An efficient electrochemical process for converting nitrate to nitrogen is based on a paired electrolysis where nitrate is reduced to ammonia at the cathode and chlorine is generated at the anode and immediately transformed to hypochlorite, which reacts with ammonia to produce nitrogen according to the reaction: 2ClO⁻+2NH₃+2OH⁻ [symbol] N₂+2Cl⁻+4H₂O. At a pure copper cathode, the electroreduction of nitrate produces ammonia and nitrite depending on the electrode potential. In that case, nitrite ions are subsequently oxidized to nitrate at the anode, which strongly decreases the efficiency of the paired electrolysis (Reyter et al., 2010). A way to overcome this problem is to use a cation exchange membrane (between the anode and the cathode) preventing nitrite to reach the anode (Corbisier et al, 2005). This requirement increases the cost and the complexity of the process. Moreover, during wastewater treatment, the pores of the membrane may be blocked with organic compounds, making it ineffective. Another limitation of copper is its poor corrosion resistance in presence of chloride, nitrate and ammonia (Korba and Olson, 1992).

There is still a need in the art for a method and system for electrochemical removal of nitrate and ammonia.

### SUMMARY OF THE INVENTION

More specifically, there is provided an electrochemical system for removing nitrate and ammonia in effluents, comprising an undivided flow-through electrolyzer, said electrolyzer comprising at least one cell, each cell comprising at least one anode and one cathode, the cathode being in a copper/nickel based alloy of a high corrosion resistance and a high electroactivity for nitrate reduction to ammonia and the anode being a DSA electrode of a high corrosion resistance and a high electroactivity for ammonia oxidation to nitrogen in presence of chloride.

There is further provided a method for removing nitrate and ammonia in effluents, comprising providing an undivided flow-through electrolyzer comprising at least one cell comprising at least one anode and one cathode, the cathode being in a copper/nickel based alloy of a high corrosion resistance and a high electroactivity for nitrate reduction to ammonia, and the anode being a DSA electrode of a high corrosion resistance and a high electroactivity for ammonia oxidation to nitrogen in presence of chloride, and circulating the effluents through the electrolyzer.

There is further provided a method for converting nitrate to nitrogen in an effluent with a N₂ selectivity of 100%, a residual nitrate concentration lower than about 50 ppm and an energy consumption as low as 10 kWh/kg NO₃⁻, comprising providing an undivided flow-through electrolyzer comprising at least one cell comprising at least one anode and at least one cathode, the cathode being in a copper/nickel based alloy of a high corrosion resistance and a high electroactivity for nitrate reduction to ammonia, and the anode being a DSA electrode of a high corrosion resistance and a high electroactivity for ammonia oxidation to nitrogen in presence of chloride; maintaining the pH of the effluent above about 9; maintaining a concentration of chloride ions above about 0.25 g/l; and modulating the current between about 1 and 20 mA/cm² during electrolysis.

There is further provided a method for converting concentrates of more than 3000 ppm of ammonia in an effluent to nitrogen with an energy consumption around 15 kWh/kg NH₃, comprising providing an undivided flow-through electrolyzer comprising at least one cell comprising at least one anode and at least one cathode, the cathode being in a copper/nickel based alloy of a high corrosion resistance and a high electroactivity for nitrate reduction to ammonia, and the anode being a DSA electrode of a high corrosion resistance and a high electroactivity for ammonia oxidation to nitrogen in presence of chloride; maintaining the pH of the effluent above about 9; maintaining a concentration of chloride ions above about 0.25 g/l and modulating the current between about 1 and 20 mA/cm² during electrolysis.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a schematic diagram of a system according to an embodiment of an aspect of the present invention;

FIG. 2 is a schematic cross sectional view of an electrolyzer according to an embodiment of an aspect of the present invention;

FIG. 3 shows linear sweep voltammograms (LSVs) recorded for different electrodes in 0.01M NaOH+0.5M NaCl with (full lines) or without (dotted lines) 0.01M NaNO₃ nitrate;

FIG. 4 show the evolution of nitrate, nitrite and ammonia concentrations during a 24 h electrolysis at −1.3 V_{SCE} at a Cu (a) and at −1.1 V_{SCE} at Cu₉₀Ni₃₀ (b), Cu₇₀Ni₁₀ (c) and Ni (d) electrodes in 0.01M NaOH+0.5M NaCl in presence of 0.01M NaNO₃;

FIG. 5 show the evolution of nitrate concentration (a) and specific energy consumption (b) during a 3 h paired electrolysis at −1.3 V_{SCE} with Cu and at −1.1 V_{SCE} with Ni, Cu₉₀Ni₁₀ and Cu₇₀Ni₃₀ cathodes in 0.01M NaOH+0.05 M NaCl in presence of 0.01 M NaNO₃;

FIG. 6 shows the evolution of nitrate concentration (ppm), specific energy consumption (kWh/Kg NO₃⁻) and current efficiency (%) with time during controlled current paired electrolysis with Cu₇₀Ni₃₀ as cathodes in 0.01M NaOH+0.05M NaCl in presence of 0.01M NaNO₃;

FIG. 7 shows the evolution of nitrate concentration (ppm), specific energy consumption (kWh/Kg NO₃⁻) and current efficiency (%) with time during controlled current paired electrolysis with Cu₇₀Ni₃₀ as cathodes in 0.01M NaOH+0.05M NaCl in presence of 0.1M NaNO₃;

FIG. 8 show the evolution of ammonia concentration with time during controlled current paired electrolysis with Cu₇₀Ni₃₀ as cathodes in 0.01M NaOH+0.05M NaCl in presence of 0.02M (a) or 0.2M (b) NH₄ClO₄; and

FIG. 9 shows the evolution of nitrate concentration (ppm) and specific energy consumption (kWh/Kg NO₃⁻) with time during controlled current paired electrolysis with Cu₇₀Ni₃₀ as cathodes in 0.01M NaOH+0.05M NaCl in presence of 0.01M NaNO₃.

### DESCRIPTION OF ILLUSTRATIVE EMBODIMENTS

The present invention is illustrated in further details by the following non-limiting examples.

In a nutshell, there is provided a method and a system for accomplishing conversion of both nitrate and ammonia into nitrogen in a membrane-less multi-electrode electrolyzer comprising electrodes having a high corrosion resistance combined with excellent electroactivities for nitrate reduction to ammonia, at the cathode side, and ammonia oxidation to nitrogen in presence of chlorine, at the anode side.

According to an embodiment of an aspect of the present invention, the system comprises an undivided flow-through electrolyzer. The electrolyzer is thus devoid of membrane, and operates in a single step, which may be advantageous in connection with the removal of nitrate and ammonia over a wide concentration range (from mg/L to g/L) with a low energy consumption.

The electrolyzer comprises electrodes that are highly resistant to corrosion and highly selective for reducing nitrate to ammonia at a copper/nickel based cathode, and oxidation of ammonia into nitrogen in presence of chlorine on a DSA-type electrode (dimensionally stable anode).

The current density of the electrolyzer is set between about 1 and 20 mA/cm².

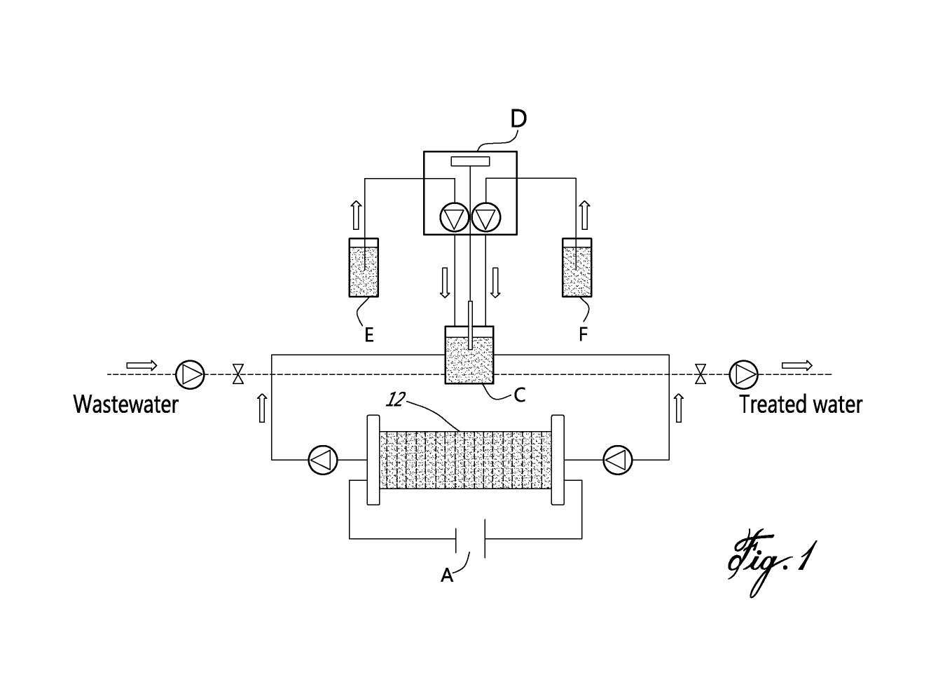

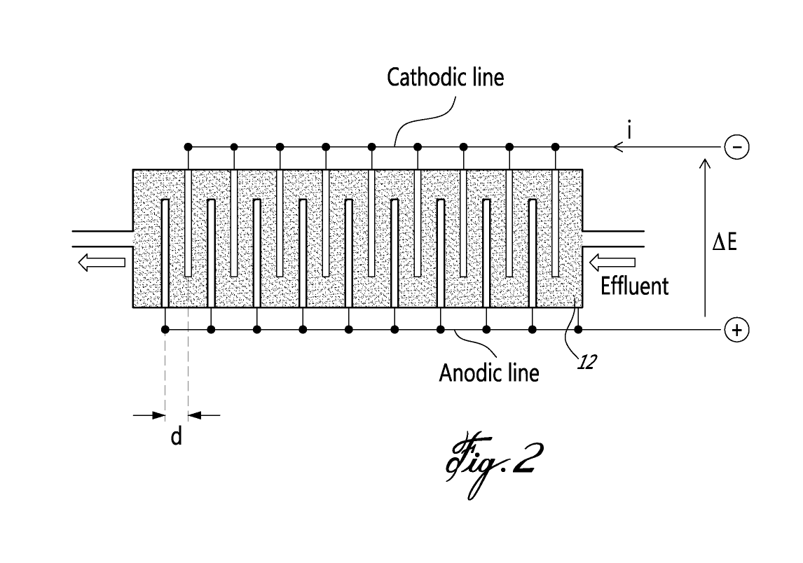

In an embodiment illustrated in FIGS. 1 and 2 for example, the electrolyzer 12 comprises Cu, Ni, Cu₉₀Ni₁₀ or Cu₇₀Ni₃₀ (wt. %) cathodes, and Ti/IrO₂ electrodes (DSA-type electrode) chosen as anodes. These electrodes may be plates or 3 dimensional, using grids or foams for example. The cathodes may be solid copper/nickel based alloys or made of a conductive substrate supporting a copper/nickel based alloy layer deposited thereon for example. All experiments were carried out at room temperature (23±1° C.). Paired electrolyses were done using a multi-cell electrolyzer without membrane in batch mode. The flow rate (200 mL/min) was controlled by two peristaltic pumps. A total of 9 anode grids and 9 cathode plates, of a geometric surface area of 8 cm² each, were alternatively placed face to face with an inter-electrode spacing (d) of 4 mm. The volume of the effluent tank (C in FIG. 1) was 200 mL, while that of the electrolyzer was 50 mL. Effluent pH was maintained around 12 by a proportional pH regulator (D) controlling two metering pumps which deliver 1 M NaOH (solution F in FIG. 1) and 1 M H₂SO₄ (solution E in FIG. 1) as needed. Note that similar results were obtained when the pH is maintained around 10 (not shown).

Electrochemical measurements were recorded using EC-Laboratory version 9.52 (BioLogic Science Instruments) installed on a computer interfaced with a VMP3 multichannel potentiostat/galvanostat (BioLogic Science Instruments). A saturated calomel electrode (SCE) was chosen as the reference electrode, joining the cell or the electrolyzer by a Luggin capillary (not shown) for example. All potentials were reported against this reference electrode. Before each experiment, the cell was purged with Ar for 30 minutes and then sealed to avoid release of formed gases.

After each electrolysis, NH₃, N₂H₄ and NH₂OH concentrations in solution were determined by UV-vis spectroscopy. Gas chromatographic analyses of N₂, Ar and N₂O were realized on a Varian™ 3000 gas chromatograph. Concentration of NO₃⁻, NO₂⁻ and Cl⁻ anions was measured using ion chromatography (Dionex™ 1500) equipped with a Dionex Ion Pac™ AS14A Anion Exchange column and a chemical suppressor (ASR-ultra 4 mm), using 8 mM Na₂CO₃/1 mM NaHCO₃ as eluent at 1 mL/min.

Polarization curves were recorded to determine the corrosion current I_{cor} and the corrosion and transpassive (pitting) potentials (E_{cor} and Eₜ, respectively) of the Cu, Ni, Cu₉₀Ni₁₀ and Cu₇₀Ni₃₀ electrodes. These tests were conducted in 0.5M NaCl+0.01 NaOH (pH=12) in absence or presence of ammonia (10 mM) or nitrate (10 mM).

The corrosion data extracted from the polarization curves are summarized in Table 1 below. Table 1 shows the corrosion potential (E_{cor}), corrosion current (I_{cor}) and pitting potential (Eₜ at 100 mA/cm²) determined from polarization curves of Cu, Ni, Cu₇₀Ni₃₀ and Cu₉₀Ni₁₀ alloys in 0.01M NaOH+0.5M NaCl without and with 0.01M NH₃ or 0.01M NO₃⁻.

TABLE 1

| | | | | 0.5M NaCl + 0.01M NaOH + | | | 0.5M NaCl + 0.01M NaOH + | | |
|---|---|---|---|---|---|---|---|---|---|
| | 0.5M NaCl + 0.01M NaOH | | | 0.01M NaNO₃ | | | 0.01M NH₄Cl | | |
| | E_{corr} | i_{corr} | Eₚ | E_{corr} | i_{corr} | Eₚ | E_{corr} | i_{corr} | Eₚ |
| | (mV) | (mA/cm²) | (mV) | (mV) | (mA/cm²) | (mV) | (mV) | (mA/cm²) | (mV) |
| Cu | −141 | 4.7 | 200 | −93 | 4.4 | 225 | −103 | 10.4 | 55 |
| Cu₉₀Ni₁₀ | −149 | 1.6 | 241 | −97 | 0.9 | 450 | −117 | 1.2 | 100 |
| Cu₇₀Ni₃₀ | −180 | 1.1 | 250 | −139 | 1.1 | 350 | −159 | 1.4 | 252 |
| Ni | −293 | 0.7 | 241 | −354 | 0.91 | 220 | −295 | 1.1 | 150 |

As shown in Table 1, nickel and cupro-nickel electrodes have corrosion rates four times and ten times slower than pure copper in presence of nitrate and ammonia, respectively. This corrosion resistance of Ni-containing materials may be attributed to the formation of a NiO/Ni(OH)₂ conductive and protective layer on the electrode surface. Moreover, the pitting potential of Cu₇₀Ni₃₀ remains 100 to 200 mV higher than that of pure copper and nickel, suggesting a better resistance to pitting corrosion in presence of chloride. According to this electrochemical corrosion study, the order of the corrosion resistance of these materials is Ni˜Cu₇₀Ni₃₀>Cu₉₀Ni₁₀>>Cu.

A next step was to evaluate the electrochemical behavior of the Cu, Ni, Cu₉₀Ni₁₀ and Cu₇₀Ni₃₀ materials toward nitrate electroreduction.

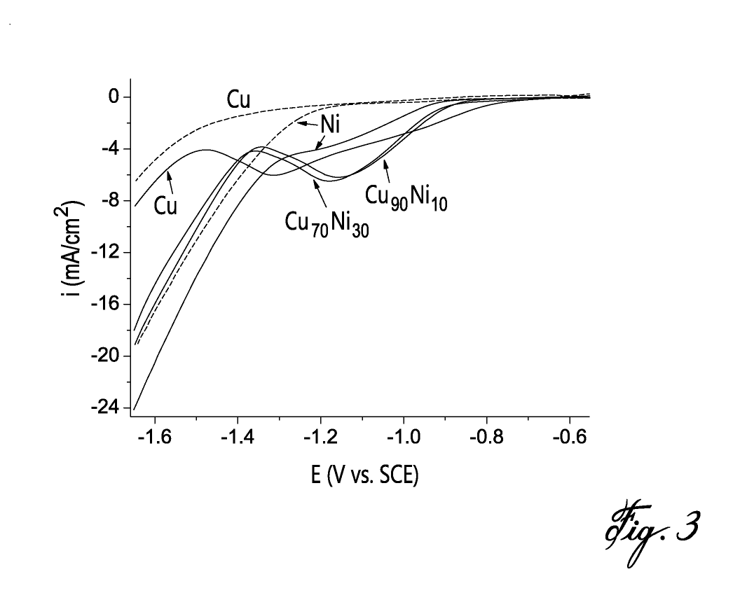

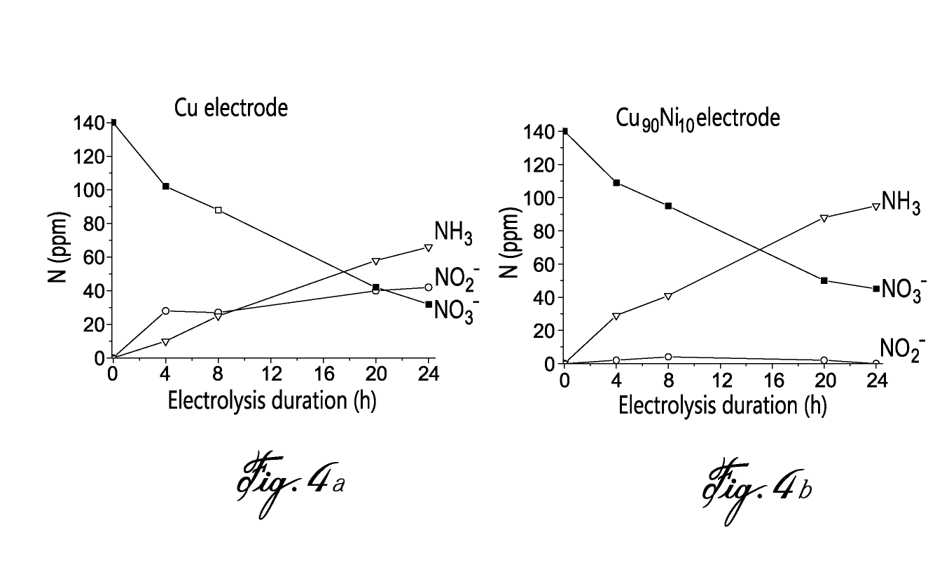

FIG. 3 shows LSVs (linear sweep voltammetry) of pure Cu and Ni electrodes in 0.01M NaOH+0.5M NaCl with (full lines) or without (dotted lines) 0.01M NaNO₃ nitrate. LSVs of pure Cu and Ni electrode without nitrate (dotted curve) show only background current until an abrupt increase of the cathodic current due to the hydrogen evolution reaction (HER) at potential lower than −1.4 and −1.1V, respectively. The LSV of copper in presence of 0.01 M nitrate shows two reduction waves. The first reduction wave at −1.0 V is attributed to the reduction of nitrate to nitrite, and the second reduction wave at −1.3 V is assigned to the reduction of nitrite to ammonia (Reyter et al., 2008). LSVs recorded in presence of nitrate of pure nickel and cupro-nickel electrodes show only one peak at −1.1 V. Prolonged electrolyses (see below) will demonstrate that this wave is attributed to the direct reduction of nitrate to ammonia.

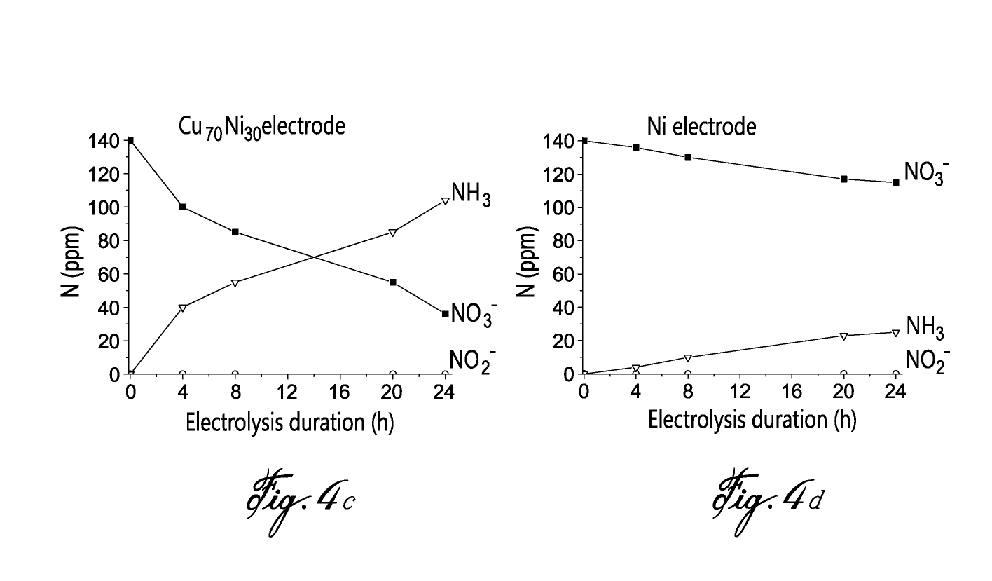

FIGS. 4a-d display the evolution of the N-concentration (ppm) of nitrate and the reaction products formed during prolonged electrolyses of 0.01 M NaNO₃ in 0.01 M NaOH+0.5 M NaCl for different cathode materials. Ammonia and nitrite were the only nitrate-reduction products detected in the solution and no N-containing gas was detected at these potentials. The nitrate destruction rate depended on the cathode used for the electrolysis. A 24 h of electrolysis was required to remove 26 ppm of the initial amount of nitrate with a pure nickel cathode whereas around 100 ppm of nitrate were removed with the investigated cupro-nickel electrodes and 110 ppm with the pure copper electrode. As expected, these results prove that copper is a good promoter for nitrate electroreduction.

It is also clearly apparent that the selectivity for nitrite or ammonia is strongly influenced by the cathode material. At pure copper cathode, both nitrite and ammonia were produced in significant proportions of 38 and 62%, respectively, whereas the only product formed at the nickel and cupro-nickel electrodes was ammonia. These results are consistent with previous reports that showed that ammonia as a nitrate-reduction product is favored in a potential region close to the hydrogen evolution reaction (HER) region, where the reaction between adsorbed hydrogen (Hads) and adsorbed nitrite to form NH₃ may occur (Reyter et al., 2010). Nickel has an excellent activity for the HER, explaining why this electrode and cupro-nickel materials exclusively produce ammonia during nitrate electroreduction. If nitrite is produced at the cathode during a paired electrolysis, these anions will be subsequently oxidized to nitrate at the anode, decreasing the efficiency of the process. In this context, cupro-nickel electrodes (Cu₇₀Ni₃₀ and Cu₉₀Ni₁₀) appear to be very promising candidates as cathode in a coupled process due to their ability to reduce nitrate to ammonia with a selectivity of 100% at a good rate. Considering that the Cu₇₀Ni₃₀ electrode shows the best activity for the electroreduction of nitrate to ammonia (FIG. 4) and a good corrosion resistance in presence of chloride, ammonia or nitrate in alkaline solution (Table 1), it was selected as cathode material for paired electrolyses.

Paired electrolyses were carried by using an un-divided (i.e. without membrane) multi-cell electrolyzer (FIG. 2) with Cu₇₀Ni₃₀ as cathode material and Ti/IrO₂ as anode material. For comparison, pure Ni and Cu were also tested as cathode materials. The effluent to be treated (250 mL) was initially composed of 0.05M NaCl+0.01M NaNO₃ (620 ppm NO₃) in 0.01M NaOH. The effluent flow rate was fixed at 200 mL/min. Because nitrate reduction occurs at different potentials depending of the cathode material, it was decided for this investigation to perform electrolysis by controlling the cathode potential. Hence, the electrolysis was performed at a cathode potential of −1.3V when copper was used, and at −1.1V when nickel and cupro-nickel were chosen as cathode.

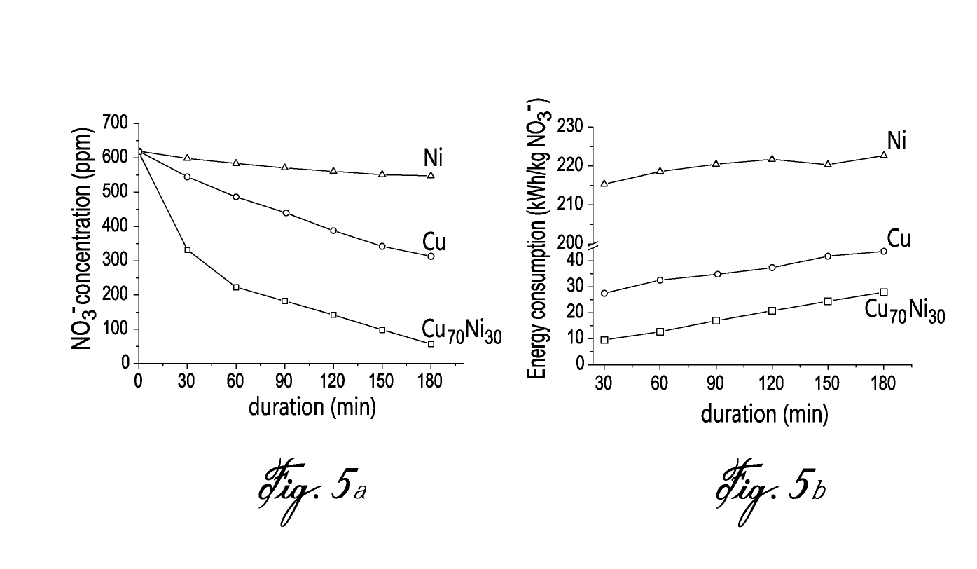

FIG. 5 show the evolution of nitrate concentration (a) and specific energy consumption (b) during a 3 h paired electrolysis at −1.3 V_{SCE} with Cu and at −1.1 V_{SCE} with Ni, Cu₉₀Ni₁₀ and Cu₇₀Ni₃₀ cathodes in 0.01M NaOH+0.05 M NaCl in presence of 0.01 M NaNO₃. Ti/IrO₂ anodes were used in all cases.

FIG. 5a shows the evolution of nitrate concentration as a function of the electrolysis time. During these electrolyses, ammonia was never detected, suggesting that it was immediately oxidized to nitrogen by direct electro oxidation and by chemical oxidation with produced hypochlorite anions. The electrolyzer with the Cu₇₀Ni₃₀ cathodes appeared to be the most efficient to convert nitrate to nitrogen. After 3 hours of electrolysis, nitrate concentration decreased to 50 ppm with this cathode whereas it reached 315 and 540 ppm with copper and nickel cathodes, respectively (FIG. 5a). The poor performance of the system with nickel cathodes is in agreement with the un-paired electrolysis results (FIG. 4). On the other hand, on the basis of the data of FIG. 4, nitrate reduction rates at copper and cupro-nickel were expected to be almost similar. However, during paired electrolysis, the nitrate destruction yield appeared smaller when copper was used as cathode, suggesting that nitrite anions (produced at pure copper cathode, FIG. 4a) were oxidized at the anode, thus decreasing the overall nitrate elimination rate due to NO₃⁻ regeneration. This side reaction was confirmed by cyclic voltammetry recorded at the anode in presence of nitrite (not shown).

FIG. 5b shows the evolution of the specific energy consumption during electrolysis. Once again, it clearly appeared that Cu₇₀Ni₃₀ is a very effective cathode material with a mean consumption of 20 kWh/Kg NO₃ compared to ˜35 and ˜220 kWh/Kg NO₃ with pure Cu and Ni cathodes, respectively. The increase of the specific energy consumption with the electrolysis time observed for all materials (FIG. 5b) is due the decrease of the nitrate destruction rate and the higher contribution of the hypochlorite reduction and hydrogen evolution side reactions as the nitrate concentration decreases. In comparison, Corbusier et al. (Corbusier et al., 2005) reported an energy consumption of 45 to 71 kWh/kg NO₃ by paired electrolysis in a two-compartment electrolyzer with copper and RuO₂—TiO₂/Ti as cathode and anode materials, respectively.

Paired electrolyses were also carried out by controlling the current in an un-divided, i.e. without membrane), multi-cell electrolyzer with Cu₇₀Ni₃₀ as cathode material and Ti/IrO₂ as anode material. The first effluent to be treated (250 mL) was initially composed of 0.05M NaCl+0.01M NaNO₃ (620 ppm NO₃⁻) in 0.01M NaOH. The second effluent was initially composed of 0.1M NaCl+0.1M NaNO₃ (6200 ppm NO₃⁻) in 0.01M NaOH. The effluent flow rate was fixed at 200 mL/min.

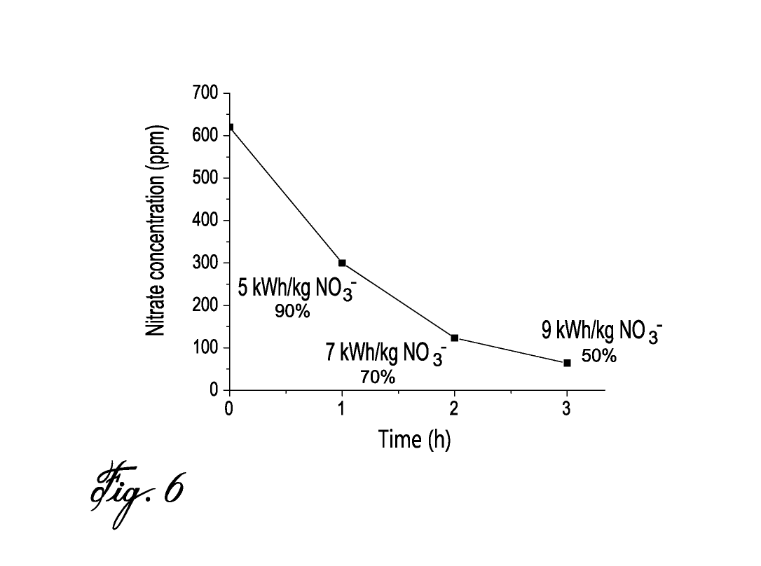

FIG. 6 shows the evolution of nitrate concentration (ppm), specific energy consumption (kWh/Kg NO₃⁻) and current efficiency (%) with time during controlled current paired electrolysis with Cu₇₀Ni₃₀ as cathodes in 0.01M NaOH+0.05M NaCl in presence of 0.01M NaNO₃, with an initial nitrate concentration of 620 ppm. Ti/IrO₂ anodes were used in all cases. Current was fixed at 300 mA (i.e. 4.2 mA/cm²). After 3 h electrolysis, nitrate concentration decreased to less than 50 ppm with an energy consumption varying from 5 to 9 kWh/kg NO₃. The selectivity for nitrogen is 100%.

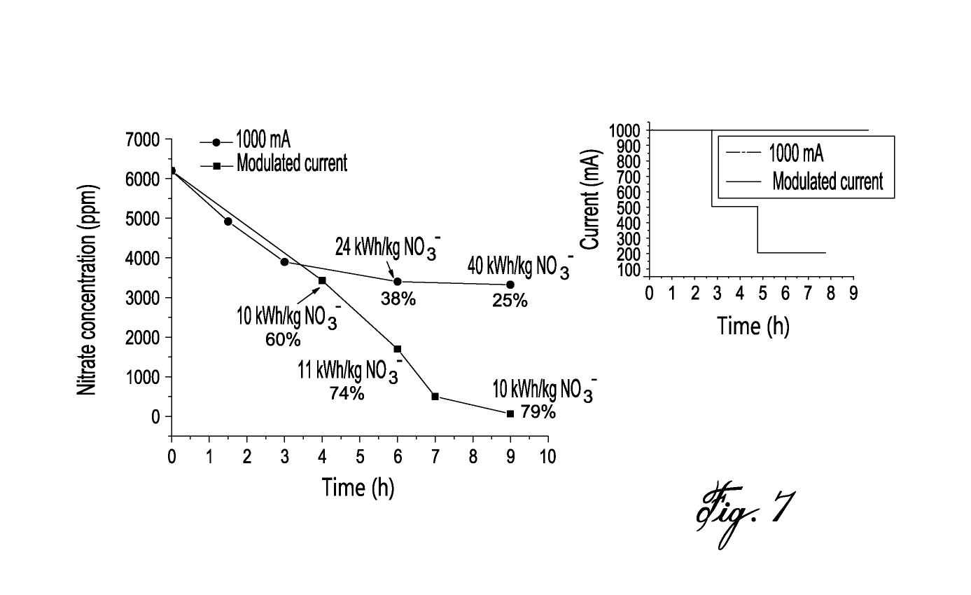

FIG. 7 shows the evolution of nitrate concentration (ppm), specific energy consumption (kWh/Kg NO₃⁻) and current efficiency (%) with time during controlled current paired electrolysis with Cu₇₀Ni₃₀ as cathodes in 0.01M NaOH+0.05M NaCl in presence of 0.1M NaNO₃. Ti/IrO₂ anodes were used in all cases. Current was fixed at 1000 mA (i.e., 13.9 mA/cm²) or was modulated from 1000 to 300 mA (i.e., 13.9 to 4.2 mA/cm²) (see inset). After 9 h electrolysis at a constant current of 1000 mA (i.e., 13.9 mA/cm²), nitrate concentration decreased to 3300 ppm and remained quasi constant. After 3 h, nitrate reduction was ineffective because of the concomitant hydrogen evolution and hypochlorite reduction occurring at the cathodes. In contrast, by modulating the current between 1000 to 300 mA (i.e., 13.9 to 4.2 mA/cm²) during electrolysis, the cathode potential also decreased and remained at optimal value for nitrate electroreduction. As a result, nitrate concentration decreased from 6200 to less than 50 ppm after 9 h, with a selectivity of 100% toward nitrogen and an energy consumption as low as 10 kWh/kg NO₃.

The electrolyzer was also evaluated for ammonia removal. Electrolyses were carried out under controlled current in an un-divided multi-cell electrolyzer with Cu₇₀Ni₃₀ as cathode material and Ti/IrO₂ as anode material. The effluent (250 mL) was initially composed of 0.1M NaCl+0.02M or 0.2M NH₄ClO₄ (340 of 3400 ppm NO₃⁻) in 0.01M NaOH. The effluent flow rate was fixed at 200 mL/min.

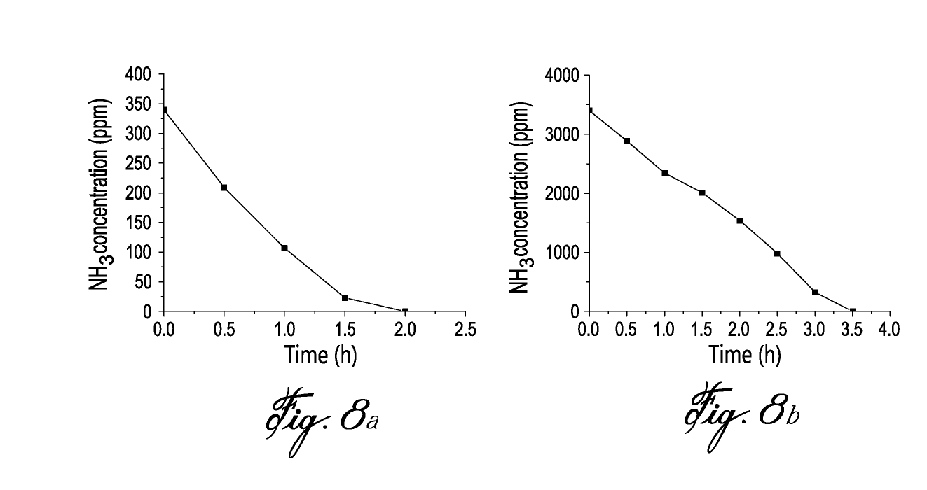

FIG. 8 show the evolution of ammonia concentration with time during controlled current paired electrolysis with Cu₇₀Ni₃₀ as cathodes in 0.01M NaOH+0.05M NaCl in presence of 0.02M (a) or 0.2M (b) NH₄ClO₄.Ti/IrO₂ anodes were used in all cases.

FIG. 8a shows the evolution of ammonia concentration during electrolysis with an initial ammonia concentration of 340 ppm. After 2 h electrolysis at a current of 400 mA (i.e. 5.6 mA/cm²), ammonia concentration decreased to less than 1 ppm with an energy consumption of 28 kWh/kg NH₃. Ammonia was entirely converted to nitrogen.

FIG. 8b shows the evolution of ammonia concentration during electrolysis with an initial ammonia concentration of 3400 ppm. After 3.5 h electrolysis at a constant current of 1000 mA (i.e. 13.9 mA/cm²), ammonia concentration decreased to less than 1 ppm with an energy consumption of 12 kWh/kg NH₃. Ammonia was entirely converted to nitrogen.

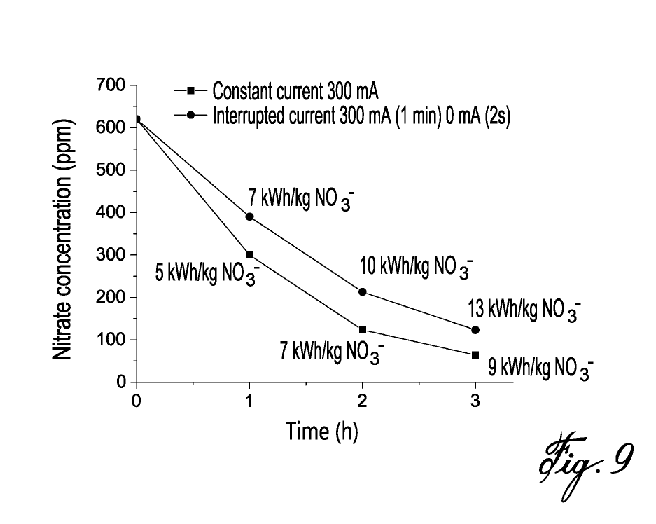

It is to be noted that during all the previous paired electrolysis experiments, the electrical circuit was opened for 2 seconds every 60 seconds of electrolysis. This proved to favor the elimination of reaction products adsorbed on the cathode, such as nitrate reduction intermediates and hydrogen and thus to reactivate the cathode for nitrate electroreduction. As a result, an increase of the nitrate removal rate and a decrease of the energy consumption were observed, as illustrated in FIG. 9. In FIG. 9, Ti/IrO₂ anodes were used in all cases and the current was fixed at 300 mA (i.e., 4.2 mA/cm²) with or without an interruption of 2 s every 1 min. Other ways of reactivate the cathode for nitrate electroreduction comprise for example reversing the polarity of the electrode and providing current pulses at intervals during the electrolysis.

As people in the art will now be able to appreciate, the present invention allows nitrate removal using a paired electrolysis process without membrane with Cu—Ni based cathodes displaying a good corrosion resistant and a high efficiency and selectivity for the reduction of nitrate to ammonia. In presence of chloride ions, typically above 0.25 g/l, for example between 1 and 2 g/l, and under optimized electrolysis operating conditions, the paired process is able to convert nitrate to nitrogen with a N₂ selectivity of 100%, a residual nitrate concentration lower than 50 ppm and an energy consumption as low as 10 kWh/kg NO₃⁻. This process is also able to convert high concentrates (e.g., more than 3000 ppm) of ammonia to nitrogen with an energy consumption around 15 kWh/kg NH₃.

Although the present invention has been described hereinabove by way of embodiments thereof, it may be modified, without departing from the nature and teachings of the subject invention as defined in the appended claims.

### REFERENCES

Corbisier, D.; Vanlangendonck, Y.; Van Lierde, A. (2005) Int. Patent WO/2005/097686, Electrochemical device and method for the removal of ammonium and nitrate ions contained in liquid effluents.
El Midaoui, A.; Elhannouni, F.; Taky, M.; Chay, L.; Menkouchi Sahli, M. A.; Echihabi, L.; Hafsi, M. (2002) Optimization of nitrate removal operation from ground water by electrodialysis, Sep. Purif. Technol., 29, 235-244.
Li, L.; Liu, Y. (2009) Ammonia removal in electrochemical oxidation: mechanism and pseudo-kinetics, J. Hazard. Mater., 161, 1010-1016.
Puckett, L. J. (1995) Identifying the major sources of nutrient water pollution, Environ. Sci. Technol., 29, 408A-414A.
Rajeshwar, K.; Ibanez, J. (2000) in: Environmental Electrochemistry Fundamentals and Applications in Pollution Abatement. Academic Press.
Reyter, D.; Belanger, D.; Roué, L. (2008) Study of the electroreduction of nitrate on copper in alkaline solution, J. Electrochem. Soc., 53, 5977-5984.
Reyter, D.; Bélanger, D.; Roué, L. (2010) Nitrate removal by a paired electrolysis on copper and Ti/IrO₂ coupled electrodes—Influence of the anode/cathode surface area ratio, Water Res., 44, 1918-1926.
Schoeman, J. J.; Steyn, A. (2003) Nitrate removal with reverse osmosis in a rural area in South Africa, Desalination, 155, 15-26.

1. An electrochemical system for removing nitrate and ammonia in effluents, comprising an undivided flow-through electrolyzer, said electrolyzer comprising at least one cell, each cell comprising at least one anode and one cathode, the cathode being in a copper/nickel based alloy of a high corrosion resistance and a high electroactivity for nitrate reduction to ammonia and the anode being a DSA electrode of a high corrosion resistance and a high electroactivity for ammonia oxidation to nitrogen in presence of chloride.

2. The system of claim 1, wherein at said cathode, nitrate is exclusively reduced to ammonia, and at said anode, chloride ions are oxidized to hypochlorite ions, said hypochlorite ions oxidizing ammonia to nitrogen.

3. The system of claim 1, wherein said cathode is one of: Cu₉₀Ni₁₀ and Cu₇₀Ni₃₀ electrodes and said anode is one of: Ti/IrO₂ electrodes.

4. The system of claim 1, wherein at least one of said anode and said cathode is one of: i) plates and ii) 3 dimensional electrodes.

5. The system of claim 1, wherein sat least one of aid anode and said cathode is one of: i) grids and ii) foams.

6. The system of claim 1, wherein said cathode is one of: i) made in a solid copper/nickel based alloy and ii) made of a conductive substrate supporting a copper/nickel based alloy layer deposited thereon.

7. The system of claim 1, further comprising a pH regulator, said pH regulator maintaining the pH of the effluents above about 9.

8. The system of claim 1, further comprising a pH regulator, said pH regulator maintaining the pH of the effluents in a range between about 10 and about 12.

9. A method for removing nitrate and ammonia in effluents, comprising:
providing an undivided flow-through electrolyzer comprising at least one cell comprising at least one anode and one cathode, the cathode being in a copper/nickel based alloy of a high corrosion resistance and a high electroactivity for nitrate reduction to ammonia, and the anode being a DSA electrode of a high corrosion resistance and a high electroactivity for ammonia oxidation to nitrogen in presence of chloride; and
circulating the effluents through the electrolyzer.

10. The method of claim 9, comprising maintaining the pH of the effluents above about 9.

11. The method of claim 9, comprising maintaining the pH of the effluents in a range between about 10 and about 12.

12. The system of claim 9, comprising maintaining a concentration of chloride ions above about 0.25 g/l.

13. The system of claim 9, comprising maintaining a concentration of chloride ions in a range between about 1 and about 2 g/l.

14. The system of claim 9, comprising setting the current density of the electrolyzer at least 1 mA/cm².

15. The system of claim 9, comprising setting the current density of the electrolyzer between about 1 and 20 mA/cm².

16. The system of claim 9, comprising modulating the current during electrolysis.

17. The system of claim 9, comprising modulating the current between about 1 and 20 mA/cm² during electrolysis.

18. The system of claim 9, comprising opening the electrical circuit at intervals during the electrolysis.

19. The system of claim 9, comprising providing current pulses at intervals during the electrolysis.

20. The system of claim 9, comprising reversing the polarity of the electrode during the electrolysis.

21. The system of claim 9, converting nitrate to nitrogen with a N₂ selectivity of 100%, a residual nitrate concentration lower than about 50 ppm and an energy consumption as low as 10 kWh/kg NO₃⁻.

22. The system of claim 9, converting concentrates of more than 3000 ppm of ammonia to nitrogen with an energy consumption around 15 kWh/kg NH₃.

23. A method for converting nitrate to nitrogen in an effluent with a N₂ selectivity of 100%, a residual nitrate concentration lower than about 50 ppm and an energy consumption as low as 10 kWh/kg NO₃⁻, comprising:
providing an undivided flow-through electrolyzer comprising at least one cell comprising at least one anode and at least one cathode, the cathode being in a copper/nickel based alloy of a high corrosion resistance and a high electroactivity for nitrate reduction to ammonia, and the anode being a DSA electrode of a high corrosion resistance and a high electroactivity for ammonia oxidation to nitrogen in presence of chloride;
maintaining the pH of the effluent above about 9;
maintaining a concentration of chloride ions above about 0.25 g/l; and
modulating the current between about 1 and 20 mA/cm² during electrolysis.

24. A method for converting concentrates of more than 3000 ppm of ammonia in an effluent to nitrogen with an energy consumption around 15 kWh/kg NH₃, comprising:
providing an undivided flow-through electrolyzer comprising at least one cell comprising at least one anode and at least one cathode, the cathode being in a copper/nickel based alloy of a high corrosion resistance and a high electroactivity for nitrate reduction to ammonia, and the anode being a DSA electrode of a high corrosion resistance and a high electroactivity for ammonia oxidation to nitrogen in presence of chloride;
maintaining the pH of the effluent above about 9;
maintaining a concentration of chloride ions above about 0.25 g/l and
modulating the current between about 1 and 20 mA/cm² during electrolysis.
